(19) United States
(12) Patent Application Publication
(10) Pub. No.: US 2008/0190562 A1
(43) Pub. Date: Aug. 14, 2008

(54) Transportation and Production System for Use in Building Tire Blanks

(75) Inventors: Jens Winkler, Hannover (DE); Jens Ludwig, Hannover (DE); Stefan Linne, Wedemark (DE); Claudia Thomfohrde, Leiferde (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/108,761

(22) Filed: Apr. 24, 2008

Related U.S. Application Data
(63) Continuation of application No. PCT/EP2006/067138, filed on Oct. 6, 2006.

(30) Foreign Application Priority Data
Nov. 22, 2005 (DE) 10 2005 055 609.4

(51) Int. Cl. B29D 30/20

(52) U.S. Cl. 156/396

(57) ABSTRACT

A transportation and production system is used in building tire blanks having at least one carcass ply, an inner layer, sidewalls, two bead cores with core profiles, a belt assembly with at least two belt plies and a tread. Drums can be positioned on transportation devices and moved along at least one continuous transportation path, having stations to be delivered to for building tire components. Selected building stations have at least two respective stations that can be traveled to alternately.

### CROSS-REFERENCE TO RELATED APPLICATIONS

This is a continuing application, under 35 U.S.C. § 120, of copending International Application No. PCT/EP2006/067138, filed Oct. 6, 2006, which designated the United States; this application also claims the priority, under 35 U.S.C. § 119, of German Patent Application DE 10 2005 055 609.4, filed Nov. 22, 2005; the prior applications are herewith incorporated by reference in their entirety.

### BACKGROUND OF THE INVENTION

### Field of the Invention

The invention relates to a transportation and production system for use in building tire blanks which have at least one carcass ply, an inner layer, sidewalls, two cores with core profiles, a belt assembly with at least two belt plies, a bandage and a tread. Drums (tire building drums) can be positioned on transportation devices and moved along at least one continuous transportation path having stations to be traveled to for building tire components.

European Patent EP 0 776 756 B1 discloses a device for building a pneumatic vehicle tire in which tire building drums are moved along a continuous path. The tire carcass is built at four carcass building stations which are spatially separated from one another and between which the drums can be moved in a controlled manner. At least one equipping device for equipping the carcass drum is provided at each of the carcass building stations. The system also has at least two belt building stations, one of which is provided for building the belt plies on a belt drum, and the other of which is provided for building the tread onto the belt plies which have already been applied. The two belt building stations are also spatially separated from one another, and the belt drum can be moved in a controlled manner between the two belt building stations. Each belt building station is also respectively provided with at least one equipping device for equipping the belt drum with the corresponding components. Furthermore, a device for combining them with the carcasses which are built in the carcass building stations and the belt assemblies which are built in the belt building stations is provided.

In that known device, the green tire is built by using moving belt drums in a type of circulation, i.e. the building drums successively travel to or call at various processing stations at which individual tire components, or groups of tire components, are placed on the belt drums. In that known device there is therefore a fixed sequence of processing stations, and although each green tire does not need to be equipped at all of the processing stations, it is not possible to perform bypassing or “overtaking” maneuvers. If a quality deficiency or a reject is already detected at the first processing station, the blank has to travel to every station until it is possible to remove it, as a result of which the production capacity is blocked. Given a production sequence for different specifications of the tires, each drum must travel to each of the processing stations, even if the processing step which is carried out there is not provided for the product with the respective specification. That also has a disadvantageous effect on production capacity. Furthermore, the displacement movements of the drums which move in succession have to be coordinated with one another, that is to say all of the drums have to start and brake simultaneously.

### BRIEF SUMMARY OF THE INVENTION

It is accordingly an object of the invention to provide a transportation and production system for use in building tire blanks or parts of tire blanks, which overcomes the hereinafore-mentioned disadvantages of the heretofore-known devices of this general type and which is substantially more variable.

With the foregoing and other objects in view there is provided, in accordance with the invention, a transportation and production system for use in building up tire blanks having at least one carcass ply, an inner layer, sidewalls, two cores with core profiles, a belt assembly with at least two belt plies, a bandage and a tread. The system comprises at least one continuous transportation path, and building stations disposed along the at least one continuous transportation path for building tire components. Selected ones of the building stations each have at least two respective stations to be traveled to alternately. Transportation devices are provided to be moved along the at least one continuous transportation path, and drums are provided to be positioned on the transportation devices.

According to the invention, optimum selection possibilities are made available for the production of a green tire by virtue of stations which can be traveled to alternately at selected building stations, and a high degree of flexibility is therefore permitted in the movement possibilities of the building drums from station to station. A transportation and production system according to the invention provides, for example, the possibility of building a green tire with a specific specification on a drum which is fed in, and of building a green tire with a different specification on a drum which is introduced subsequently. The alternative stations also permit “feeding through” of drums without processing. With the invention, a large number of green tires with very different specifications can therefore be manufactured with a high degree of flexibility.

In accordance with another embodiment variant of the transportation and production system of the invention, the stations which can be traveled to alternately, may be alternatives to the respective building station. At such stations, variants of a tire component or of a group of tire components are applied, for example treads composed of different rubber mixtures or different core/apex/flipper combinations.

In accordance with a further embodiment of the invention, the stations which can be traveled to alternately can, however, also be associated with different building stations. In this way, tires with different specifications can be built particularly efficiently in various ways.

In accordance with an added embodiment of the invention, the green tires can be built very economically in terms of time if the stations which can be traveled to alternately, or at least some of those stations, are traveled to simultaneously by a corresponding number of drums.

In accordance with an additional embodiment of the transportation and production system of the invention, the transportation path has transportation path elements which are disposed in the manner of a grid, or is composed of transportation path elements which are disposed in the manner of a grid. The elements are disposed in such a way that grid elements which adjoin one another have at least one vertex in common. This provides a particularly variable way of producing or building green tires since, depending on the configuration of the individual grid elements, a large number of green tires with very different specifications can be built up. A configuration of the grid elements with vertices or nodes which have up to three alternatives for the further transportation of a drum is particularly favorable.

In accordance with yet another relatively simple embodiment of the transportation and production system of the invention, during their transportation the drums maintain their original orientation which is defined when they are fed in.

In another alternative there is provision for the drums to be rotated at vertices in such a way that either their orientation is adapted to the transportation direction, or there is provision for them to be rotated as desired, in particular in increments of 90°. By rotating the drums it is possible to ensure particularly advantageous accessibility of the drums during the next building step which is provided.

In accordance with yet a further embodiment of the transportation and production system of the invention, those stations which are provided, or are necessary, for building tire carcasses form finished green tires. However, the transportation and production system can also be provided with those stations which are necessary to build tire carcasses.

In accordance with a concomitant embodiment of the invention, the transportation and production system can also advantageously be configured in such a way that it has a module with stations for building tire carcasses and a module with stations for building finished green tires from tire carcasses.

Other features which are considered as characteristic for the invention are set forth in the appended claims.

Although the invention is illustrated and described herein as embodied in a transportation and production system for use in building tire blanks, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1-8 are diagrammatic, top-plan views of different embodiment variants of transportation and production systems according to the invention for producing tire blanks or parts of tire blanks.

### DETAILED DESCRIPTION OF THE INVENTION

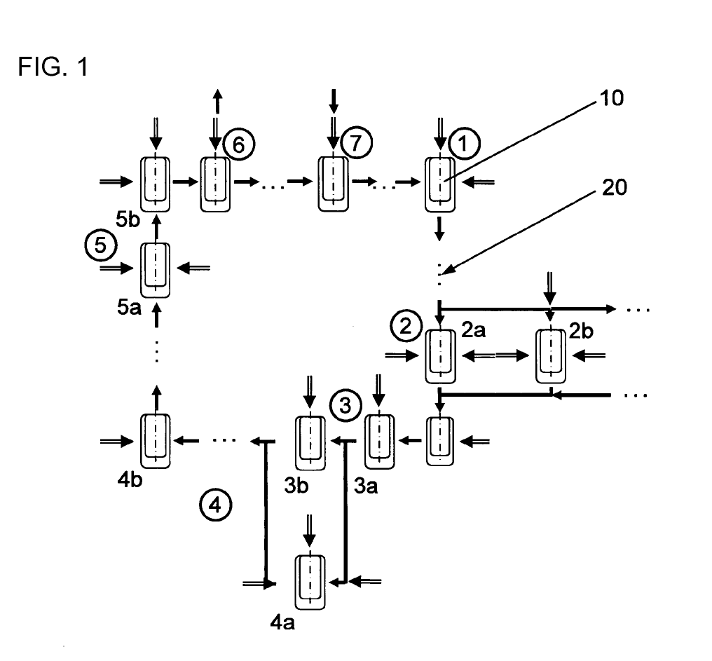

The embodiments of the transportation and production system shown in FIGS. 1 to 8 are described in more detail below with reference to the building of a tire carcass to form a finished tire blank and with reference to the building of a tire carcass.

The tire carcass, which is to be built to form the finished tire blank, can be built on a conventional locationally fixed carcass station. The tire carcasses which are fed into the transportation and production system according to the invention can have different specifications, three of which are mentioned below by way of example.

According to one possible specification A, the finished tire carcass has an inner layer, a carcass ply and two core assemblies composed of bead cores and core profiles. In another possible specification B, the two core assemblies are surrounded with reinforcing plies, for example. A further possible specification C has two carcass plies. The specifications A, B and C are, as mentioned, only exemplary and further variants (which are not described herein in more detail) of specifications are possible.

Referring now to the figures of the drawings in detail and first, particularly, to FIG. 1 thereof, there is seen a transportation and production system with a transportation path 20 which is illustrated by dotted lines and which is continuous. For example, the feeding in of drums 10 can take place at a station 7, the transfer of tire carcasses onto the drums 10 at a station 1 and the removal of finished tire blanks and the extraction of the drums 10 at a station 6. Each drum 10 is positioned at the feeding-in station 7 on a non-illustrated transportation device, for example a carriage, and it remains on it until it leaves the system at the extraction station 6. A number of transportation devices with drums 10 are moved from processing station to processing station along the transportation path 20 on guide devices, in particular guide rails. At the first station, the transfer station 1, tire carcasses with identical or different specifications, for example the specifications A, B, C, can be successively transferred onto the drums 10. At the first processing station 2, which is composed of two parallel stations 2a, 2b, the folding over of the carcass ply on those tires carcasses which require it can take place at the station 2b. Tire carcasses with a carcass fold which has already been carried out are transported onward at the station 2a to an empty station.

The next station which is traveled to is a building station 3 for a belt assembly. The building station 3 for the belt assembly has two stations 3a, 3b which have to be traveled to successively. For example, a first belt ply is applied at the belt station 3a and a second belt ply at the belt station 3b. A belt bandage can be applied to the first belt ply at a station 4a, which can be traveled to before the station 3b, but does not have to be traveled to, and the drum 10 can subsequently be moved into position at the station 3b for the application of the second belt ply. A station 4b, at which the finished belt is provided with a belt bandage, is subsequently traveled to. It is additionally possible to provide two parallel stations 3a, 3b which can be traveled to alternately by one transportation device or simultaneously by two transportation devices. At the building station 3a it is possible, for example, to position a belt assembly composed of two belt plies through the use of an equipping device on a tire carcass with the specification A. At the building station 3b it is possible, for example, to provide a tire carcass with an identical or different specification, for example the specification B, with a belt assembly which has two belt plies having strength members which enclose a different angle with the circumferential direction than the belt plies of the belt assembly which is applied at the station 3a. The equipping devices are supplied by corresponding supply devices and feed devices. At the next station 5a which is traveled to by each drum 10, the tire blank is provided with a tread base. At a subsequent station 5b, a tread cap and the sidewalls are applied so that the green tire is ready for vulcanization. The finished green tires are removed from the drums 10 at the station 6 or removed from the circulation together with the drums 10.

FIG. 1 shows the transportation path 20 in the form of a rectangle, with no rotational movements of the transportation devices being carried out at vertices, so that the drums 10 always remain oriented to the same extent in one specific direction along transportation path 20. The short arrows with a double bar show the accessibility of the drums 10 at the individual stations 1, 2, 3, 4, 5 and 6. The single arrows represent the transportation path 20 and branches at building stations with a plurality of parallel stations.

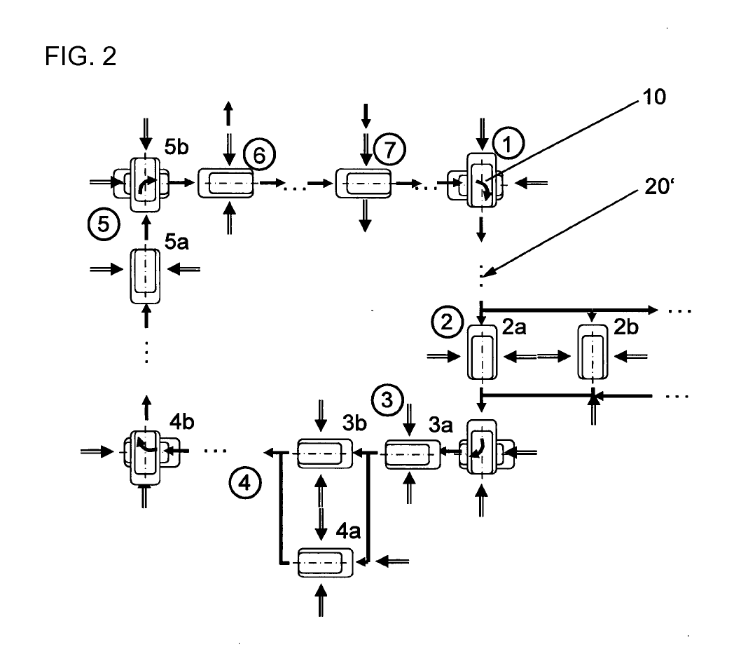

FIG. 2 shows an alternative to the system shown in FIG. 1, having a transportation path 20′ which runs along a rectangle, with the guide devices for the transportation device being embodied in such a way that the transportation devices with the drums 10 are rotated in each case through 90° at the corners so that the drums 10 retain their orientation with respect to the transportation path 20′ during the transportation along the path 20′. The transfer station 1, the belt building station 3 with two stations 3a, 3b, the station 4 with two parallel stations 4a, 4b for applying belt bandages, and the stations 5a, 5b for applying the tread and the sidewalls, are also provided in this embodiment variant. The arrows with a double bar show the accessibility of the drums 10 for the application of the components or the processing of the components, and the arrows with a single bar represent the travel path of the drums 10.

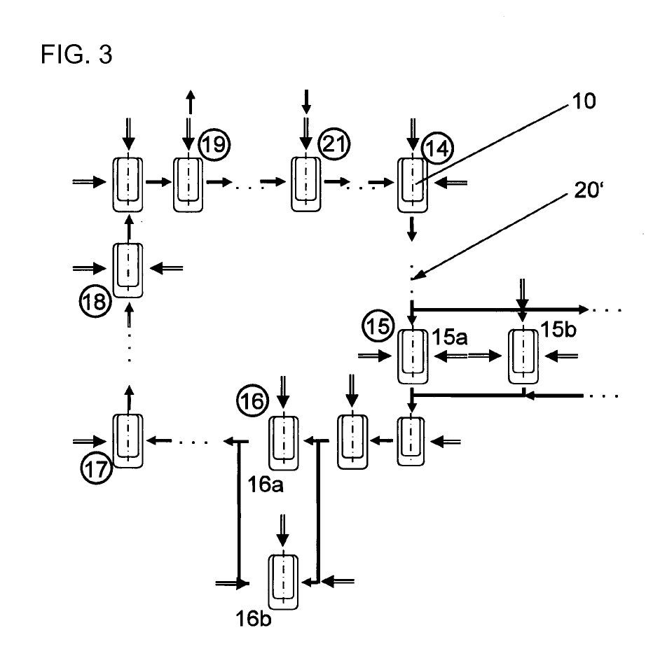

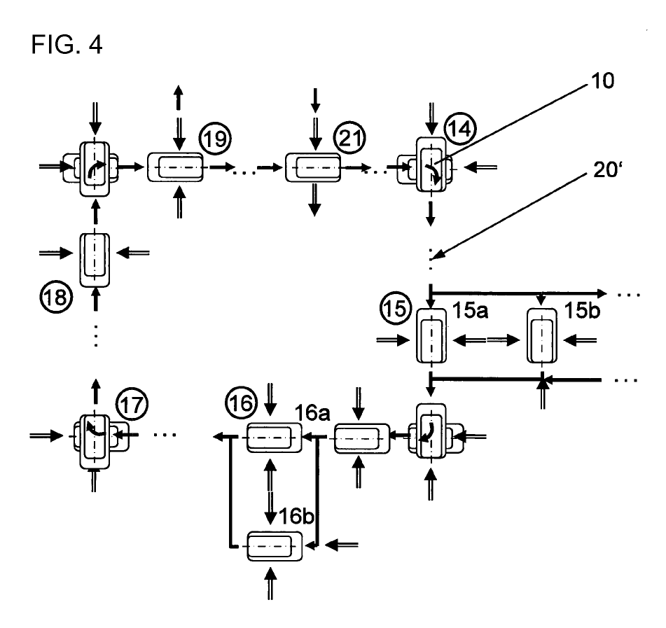

Transportation and production systems which are implemented according to the invention can also be used to build tire carcasses. FIG. 3 and FIG. 4 show two embodiment variants which largely correspond, with the drums 10 in FIG. 3 maintaining their original orientation, and with the drums 10 being rotated in FIG. 4 at the corners of the transportation path 20′ so that they retain their orientation with respect to the transportation direction. The drums 10 are successively fed in at a station 21. The sidewalls are applied at the first station 14 which is traveled to. Inner layers composed of different mixtures can be applied at two parallel stations 15a, 15b of an inner layer building station 15. A bead reinforcement building station 16 is subsequently traveled to, in which case two parallel stations 16a, 16b at which bead reinforcements of different constructions can optionally be applied, are also provided in this case. A station 17 at which the carcass ply or plies is/are applied follows in the transportation path 20′. The core assemblies are positioned at a station 18. The finished tire carcass is removed from the respective drum 10 at the station 19, and the drums 10 are extracted at the station 21.

The finished tire carcass can be assembled with a completely built belt/tread assembly to form a finished green tire. Alternatively, it is possible to complete the built tire carcasses, as is illustrated in FIGS. 1 and 2, to form the finished green tire in a second module of a transportation and production system.

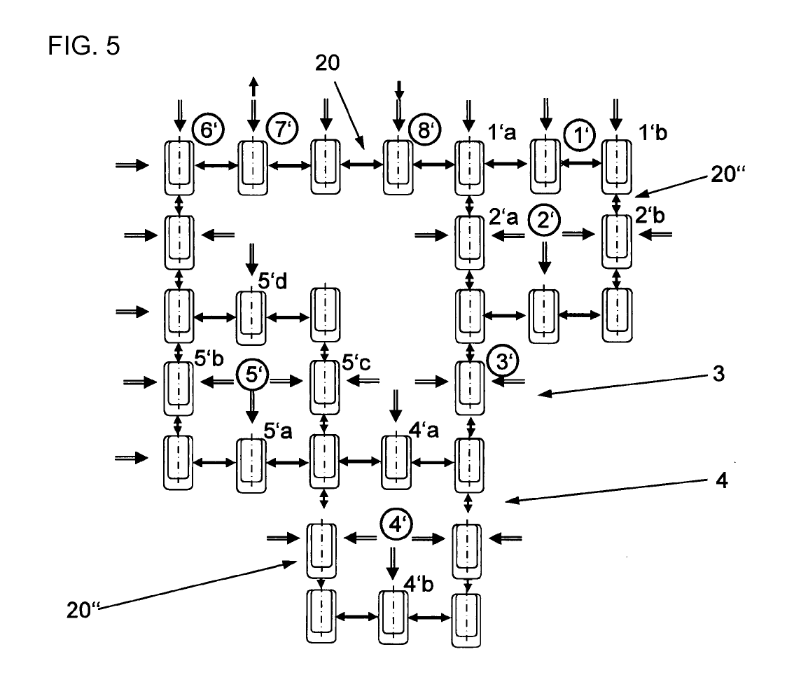

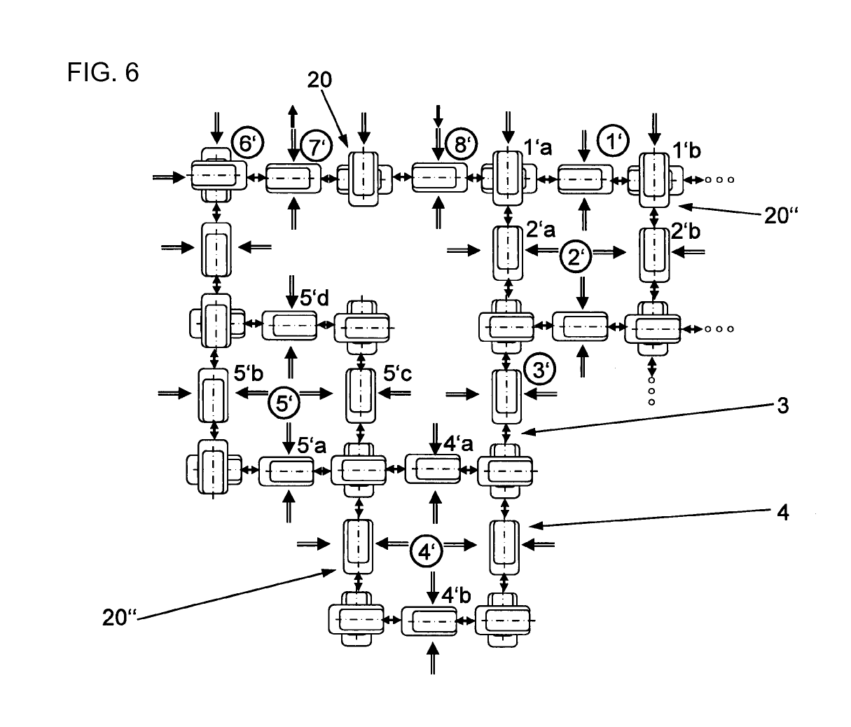

FIGS. 5 and 6 show variants of another embodiment of a transportation and production system for building a tire carcass to form a finished tire blank. The very variable transportation path 20, 20′ has a number of continuous, preferably rectangular elements 20″ which are disposed in the manner of a grid. There are grid element vertices at which the transportation direction is predefined, these being, for example, outer vertices, in addition to grid vertices with two selection possibilities for the transportation path and those with three such selection possibilities. The drums 10 are fed in at a station 8′ and tire carcasses with identical or different specifications are transferred onto the drums 10 at two parallel stations 1′a, 1′b of a transfer station 1′. At this location, the grid-like structure can be expanded in order to be able to transfer more than two tire carcasses onto drums 10 simultaneously. A subsequent station 2′ can have a feed-through station 2′a and a station 2′b at which the folding over of the carcass ply is carried out. The carcasses which are transferred at the stations 1′a or 1′b can optionally travel to the stations 2′a and 2′b, and the arrows which point in both directions along the transportation paths illustrate these possibilities. The belt assembly is applied to the carcasses at a station 3′. Alternatives for the building of the belt assembly could also be made available at connected grid elements in this case. A station 4′ forms a further grid element with the possibility of applying different belt bandages, which differ, for example, in the material of their strength members, at two parallel stations 4′a, 4′b. A tread/sidewall application station 5′ is a separate grid element with a station 5′a for applying a tread base and subsequent station 5′b for applying a tread cap and the sidewall components. A tread base and a tread cap could be applied at a station 5′c which is traveled to in parallel, and a tread cap composed of a different mixture and the sidewall components could be applied at a station 5′d which adjoins the station 5′c. The finished tire carcasses are removed at a removal station 6′, and the empty drums 10 are extracted at a station 7′. In the embodiment variant shown in FIG. 6, there is provision for the drums 10 to be rotated at the vertices of the grid elements, in which case the drums can be rotated in increments of, for example, 90°, 180° and 270°, in each case as a function of the requirements made at the subsequent stations in terms of the building of the green tire.

The system, which is composed of continuous transportation path components or grid elements 20″ which are, however, connected to one another through the use of vertices and nodes, can be extended as desired and can therefore be configured in an extremely flexible way.

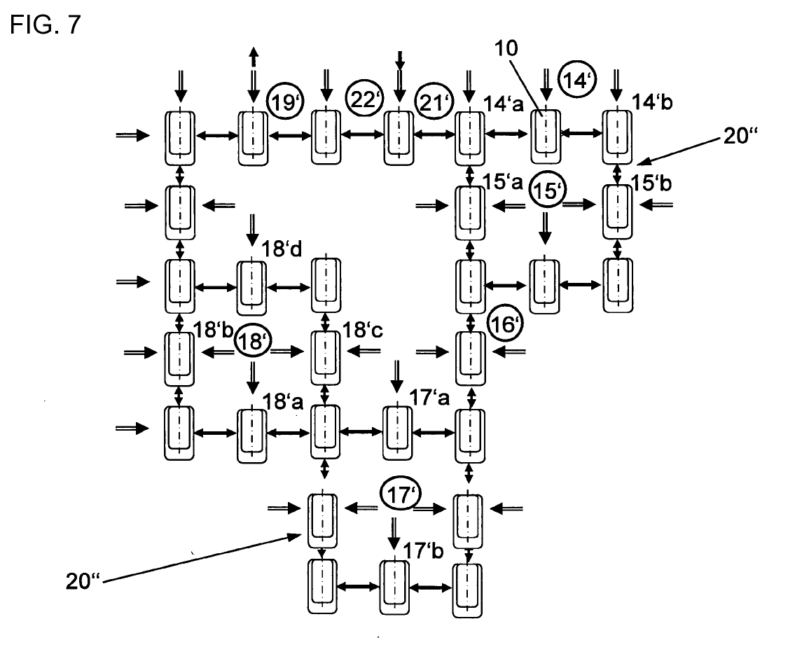

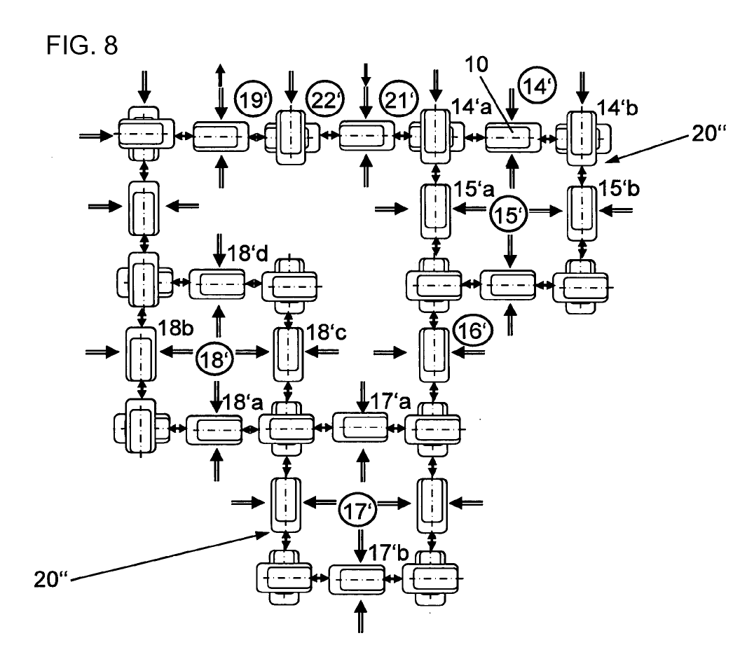

FIGS. 7 and 8 show embodiments of the building of a tire carcass in a production system with transportation path elements 20″ which are built in the manner of a grid. The embodiment according to FIG. 8 additionally provides that the drums 10 can be rotated at vertices, for example in increments of 90°, in a way which is analogous to the embodiment according to FIG. 6.

The drums 10 are successively placed on the transportation devices at a station 21′. A station 14′ for applying the sidewall has two alternatives, so that at stations 14′a and 14′b it would be possible, for example, to apply sidewalls with different mixture compositions. Inner layers made of two different mixtures can be applied at a station 15′ with two parallel stations 15′a, 15′b. Subsequently, bead reinforcements are applied at a station 16′, and a carcass ply is applied at a subsequent station 17′, which also forms a grid element. In this case, at the stations 17′a, 17′b, it is possible to choose between two alternative carcass plies, which differ from one another, for example, in terms of the material of the strength member. The next grid element forms a station 18′ for applying the core assembles with alternative stations 18′a, 18′b, 18′c and 18′d for applying different core/apex/flipper combinations. The finished tire carcasses can be removed from the drums 10 at a station 19′, and the drums 10 are removed from the transportation devices and extracted at a station 22′.

In all of the embodiment variants, the number of drums 10 within the transportation and production system is less than or equal to the number of possible stopping or building stations. Furthermore, there may be provision for drums 10 to be fed in or extracted at more than one or two locations. The supply devices for the drums 10 for supplying current, air, water and the like are not transported along with the transportation devices.

1. A transportation and production system for use in building tire blanks having at least one carcass ply, an inner layer, sidewalls, two cores with core profiles, a belt assembly with at least two belt plies, a bandage and a tread, the system comprising:
at least one continuous transportation path;
building stations disposed along said at least one continuous transportation path for building tire components;
selected ones of said building stations each having at least two respective stations to be traveled to alternately;
transportation devices to be moved along said at least one continuous transportation path; and
drums to be positioned on said transportation devices.

2. The transportation and production system according to claim 1, wherein said stations to be traveled to alternately are alternatives to said respective selected building station.

3. The transportation and production system according to claim 1, wherein said stations to be traveled to alternately are associated with different ones of said building stations.

4. The transportation and production system according to claim 1, wherein said stations to be traveled to alternately can be traveled to simultaneously by a corresponding number of said drums.

5. The transportation and production system according to claim 1, wherein said at least one continuous transportation path has transportation path elements disposed as a grid with adjoining grid elements having at least one vertex in common.

6. The transportation and production system according to claim 5, wherein said grid is configured in a square shape.

7. The transportation and production system according to claim 5, which further comprises vertices and nodes having up to three alternatives for further transportation of a drum.

8. The transportation and production system according to claim 1, wherein said drums have an original orientation defined when said drums are fed in, and said drums maintain said original orientation during transportation of said drums.

9. The transportation and production system according to claim 1, wherein said at least one continuous transportation path has a transportation direction and vertices, and said drums are rotatable at said vertices into an orientation corresponding to said transportation direction.

10. The transportation and production system according to claim 1, wherein said at least one continuous transportation path has vertices, and said drums are rotatable as desired at said vertices.

11. The transportation and production system according to claim 10, wherein said drums are rotatable in increments of 90° at said vertices.

12. The transportation and production system according to claim 1, wherein said stations include stations for building tire carcasses to form finished green tires.

13. The transportation and production system according to claim 1, wherein said stations include stations for building a tire carcass.

14. The transportation and production system according to claim 1, which further comprises a module with stations for building tire carcasses and a module with stations for building finished green tires from tire carcasses.
